(19) United States
(12) Patent Application Publication
(10) Pub. No.: US 2011/0183594 A1
(43) Pub. Date: Jul. 28, 2011

(54) Plasma cutting machine exhaust apparatus and method

(75) Inventors: John J. Toben, Cedar Rapids, IA (US); Gerald J. Lavenz, Anamosa, IA (US); Gary L. Dickinson, River Grove, IL (US)

(73) Assignee: JWT L.L.C., Cedar Rapids, IA (US)

(21) Appl. No.: 12/929,407

(22) Filed: Jan. 21, 2011

Related U.S. Application Data
(60) Provisional application No. 61/282,325, filed on Jan. 22, 2010.

(51) Int. Cl. F24F 7/04; B23K 10/00

(52) U.S. Cl. 454/66

(57) ABSTRACT

An exhaust system for a plasma cutting machine which uses an outside air supply to provide needed airflow to a cutting table thereof is disclosed. Airflow into the cutting table may be controlled and directed to select zones of the cutting table.

### RELATED APPLICATION

The application hereby claims the benefit under 35 U.S.C. §119(e) of U.S. Provisional Application Ser. No. 61/282,325, filed Jan. 22, 2010, entitled PLASMA CUTTING MACHINE EXHAUST APPARATUS AND METHOD, which application is incorporated herein by reference in its entirety.

### FIELD OF INVENTION

The present invention relates to exhaust systems for plasma cutting machines and methods of using the same.

### BACKGROUND OF INVENTION

Typical plasma cutting machines have a cutting table with one or more exhaust holes in a bottom or a side of the cutting table. FIG. 1 illustrates a typical prior art plasma cutting machine 100. Exhaust holes (not shown) in the plasma cutting table 102 exit at exhaust duct 104 to an opening 106 in a building wall or roof to remove smoke which is generated during the cutting of a sheet of metal 108 by the plasma cutting torch 110. A fan (not shown) is placed in the duct to draw exhaust air from the cutting table to the outside of the building. When a full sheet of metal 108 is placed on the cutting table 102 to be cut, the sheet closes most of a top surface of the cutting table to create a chamber to catch the smoke from the cutting process. A perimeter 112 around the sheet on the table is left open to provide an intake air supply 114 for the exhaust system. The air for this exhaust is either heated or cooled air from inside of the building which is drawn into the table and the exhaust system. When this heated or cooled air is removed from inside of the building, energy is wasted.

The exhaust systems for presently known plasma cutting machines and methods have various shortcomings including the waste of energy as noted above. The present invention addresses these shortcomings as seen hereafter.

### SUMMARY OF INVENTION

A primary object of the present invention is to provide exhaust systems for plasma cutting machines which use an outside air supply instead of heated or air conditioned room air to save on energy costs.

Another primary object of the present invention is to provide exhaust systems for plasma cutting machines which are more energy efficient than presently known plasma cutting machines.

The exhaust system for plasma cutting machines of the present invention includes a cutting table having integral intake and exhaust air ducts along the bottom of the cutting table. These ducts of the cutting table connect to intake and exhaust air ducts of the exhaust system. The other end of the intake and exhaust air ducts connect to openings in the exterior walls or roof of the building. The invention uses an outside air intake supply for the exhaust system of the cutting tables. Fan pressure is introduced into the duct system to facilitate rapid air movement and exhaust airflow through the table.

Accordingly, the exhaust system of the present invention uses an outside air supply for the table exhaust system. By using an outside air supply for the exhaust system, heated or cooled shop air is not drawn into the table and removed from the building by the table exhaust. As such, energy loss during the cutting process is virtually eliminated.

Additionally, the exhaust system of the present invention may control the airflow to select zones of the cutting table. This may increase the energy savings, efficiency and performance of the plasma cutting machine.

These and other objects of the invention will be apparent from the following description of the preferred embodiments of the invention and from the accompanying drawings.

### BRIEF DESCRIPTION OF THE DRAWINGS

Referring to the drawings:

FIG. 1 is a perspective view of a typical prior art plasma cutting machine;

FIG. 2 is a top view of a plasma cutting machine using the exhaust system of the present invention and having a zone system with damper air control;

FIG. 3 is a partial cross-sectional end view of a plasma cutting machine using the exhaust system of the present invention showing a cutting table with a single damper in the bottom thereof;

FIG. 4 is a partial top view of a plasma cutting machine showing different parts of the exhaust system of the present invention;

FIG. 5 is a partial cross-sectional end view of a plasma cutting machine using the exhaust system of the present invention showing a cutting table with dampers in the intake chamber and the exhaust chamber; and

FIG. 6 is a partial cross-sectional end view of a plasma cutting machine using the exhaust system of the present invention showing a cutting table with an intake duct and an intake chamber on each side of the table and a damper in an exhaust chamber therebetween.

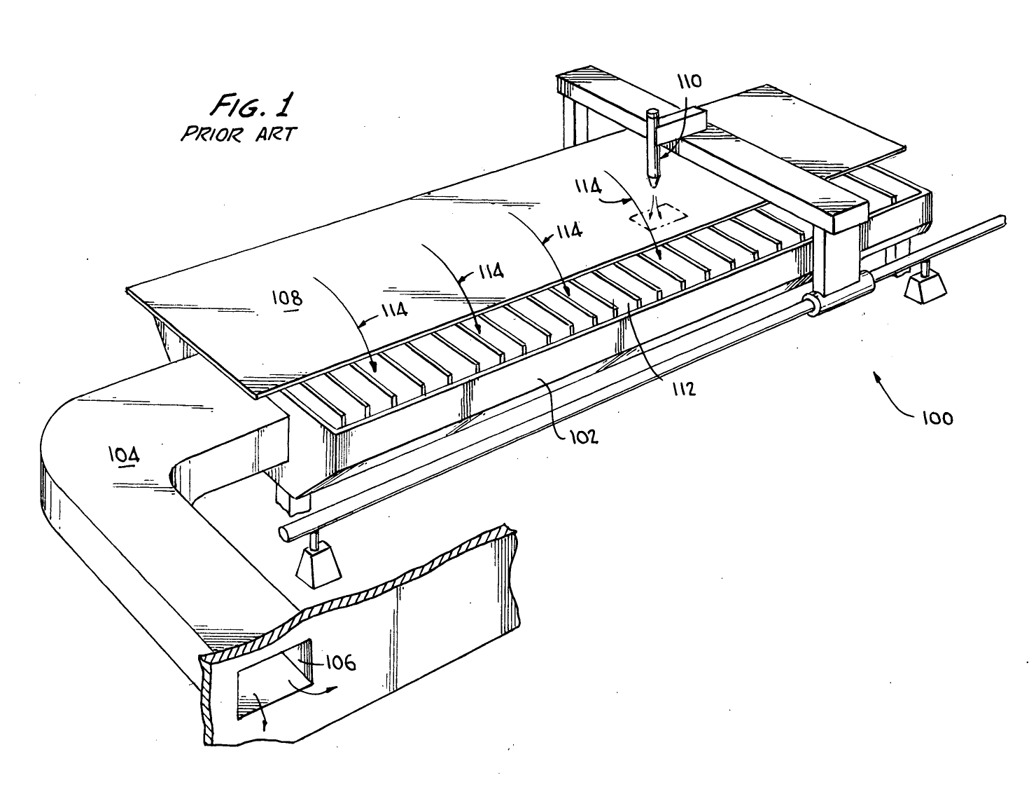

### DETAILED DESCRIPTION OF THE PREFERRED EMBODIMENTS

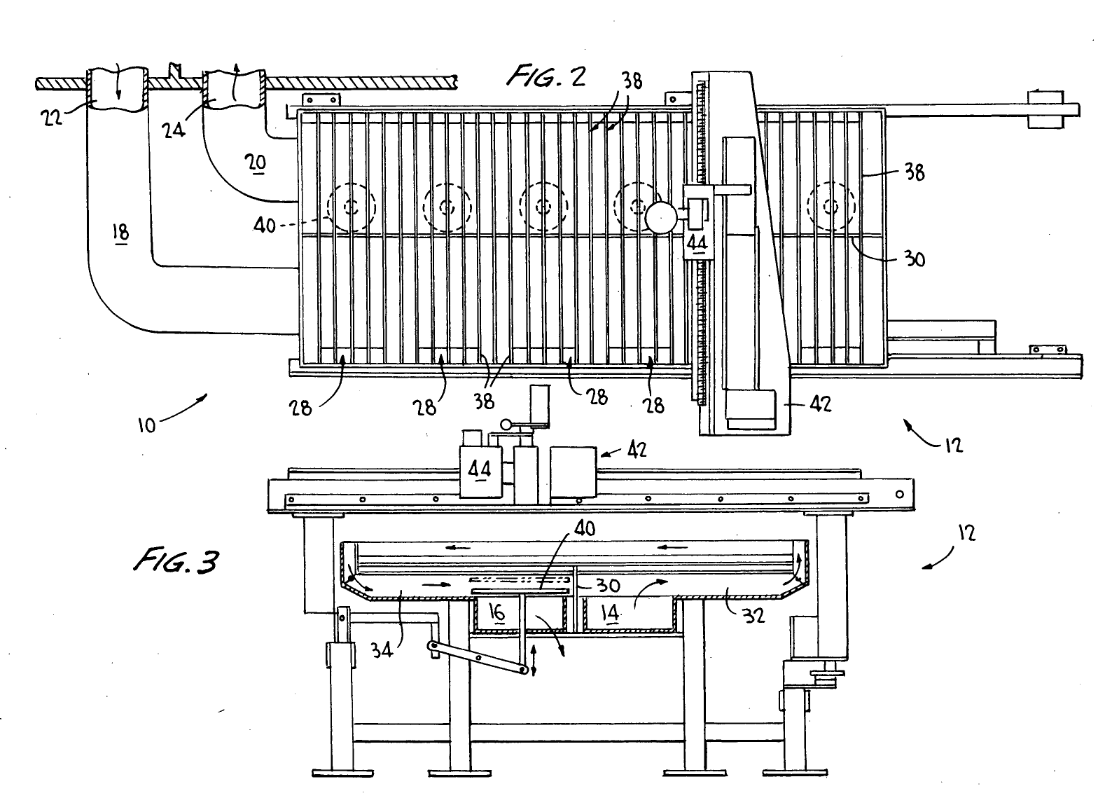

Referring to FIGS. 2-6, the present invention relates to an exhaust system 10 for a plasma cutting machine and its method of use. The exhaust system 10 for plasma cutting machines includes a cutting table 12 which includes an integral intake duct 14 and exhaust duct 16 along a bottom of the cutting table 12. This design uses an outside air intake to supply the cutting table 12 and exhaust system 10 thereof with air. The terms “outside air intake” or “external source of air” or variations thereof as used herein mean an intake of air from a source outside of a closed area having the plasma cutting machine, e.g., air from outside of a building housing the plasma cutting machine. This design also exhausts air from the cutting table 12 through the exhaust system 10 to an outside air exhaust opening, e.g., outside of a building housing the plasma cutting machine, as disclosed hereafter.

More specifically, the exhaust system 10 has an intake air duct 18 and an exhaust air duct 20. The intake air duct 18 connects the intake duct 14 of the cutting table 12 to an outside air intake opening 22 in an exterior wall or roof of a building housing the exhaust system of the present invention. The exhaust air duct 20 connects the exhaust duct 16 of the cutting table 12 to an outside air exhaust opening 24 in the exterior wall or roof of the building housing the exhaust system 10. Further, fan pressure is introduced into the exhaust system 10 to facilitate rapid air movement and exhaust air flow through the cutting table 12.

The exhaust system for the plasma cutting machine uses an outside air supply or external source of air for the cutting table 12 and the exhaust system 10. By using an outside air supply, air from inside of the building, i.e., heated air in the winter and air conditioned air in the summer, is not drawn into the cutting table 12 and is not removed from the building by the cutting table exhaust system. Accordingly, energy loss during the cutting process is virtually eliminated with the present invention since internal room air is not used.

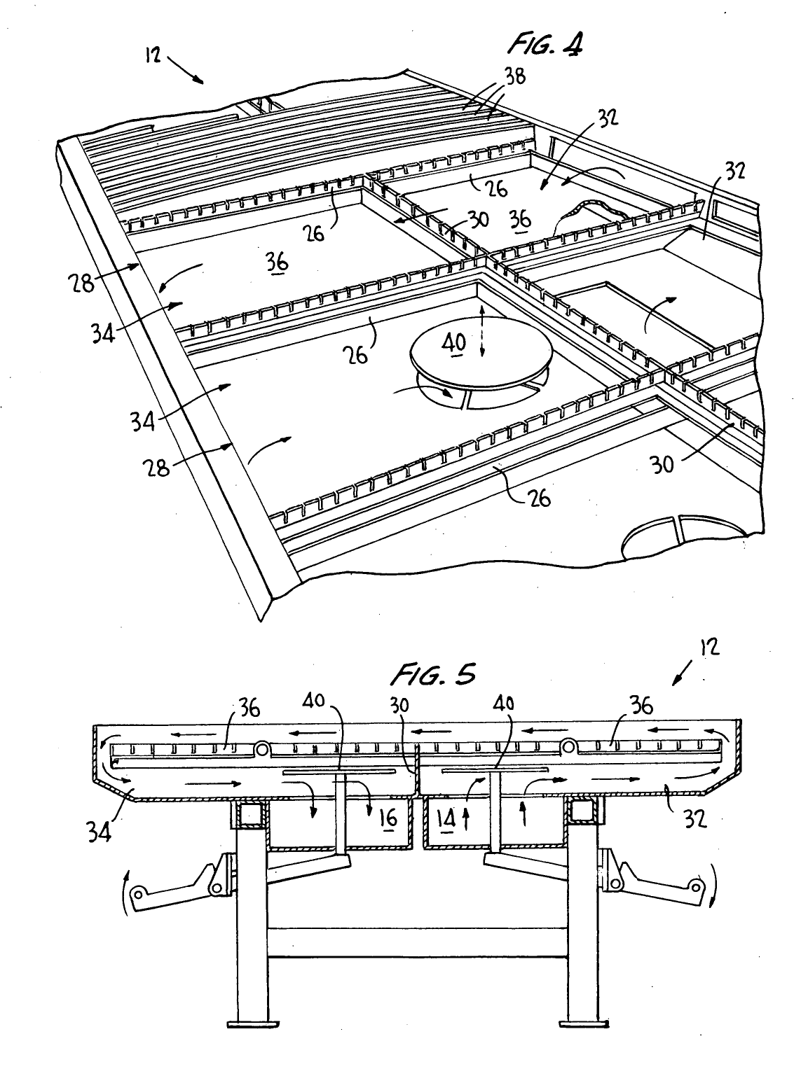

The cutting table 12 can have a single zone or a plurality of zones therein. In a preferred embodiment of the invention, the cutting table 12 includes a plurality of zones. In a presently preferred embodiment, there are six zones as shown in FIG. 2. Each zone is formed by baffles 26 that divide the cutting table 12 into smaller sections or cutting zones 28. Each cutting zone 28 has another baffle 30 that divides each cutting zone 28 into separate air intake and exhaust chambers 32, 34. The intake chamber 32 has an opening to the intake duct 14 and exhaust chamber 34 has an opening to the exhaust duct 16 running underneath the cutting table 12. As shown for example in FIG. 4, air flows above and below the baffles 30 in the cutting zones 28 of the cutting table 12. More particularly, air flows from the external air source through intake opening 22, through intake air duct 18, intake duct 14 and intake chamber 32. Air is then exhausted from intake chamber 32 through exhaust chamber 34, exhaust duct 16, exhaust air duct 20 and through exhaust opening 24 to the outside of the building. These chambers and/or zones can have dampers therein to control the air flow therein as set forth hereafter.

Further, the cutting table 12 can include internal baffle pans 36 which are placed at the top of the intake chamber 32 and the exhaust chamber 34 to close off the top surface of these chambers 32, 34 in each zone 28. The baffle pans 36 can also close off a bottom surface of sheet support slats 38 in the cutting table 12. In the internal air intake and exhaust chambers 32, 34 in the cutting table 12, the baffle pans 36 direct airflow to the sides of the cutting table 12. This airflow continues through the internal duct chambers in the cutting table 12 from the air intake duct 14 to the intake and exhaust chambers 32, 34 to an area above the internal baffle pans 36 at the ends of the sheet support slats 38 and through exhaust duct 16.

A plurality of sheet support slats 38 are arranged in the cutting table to support the metal sheet during cutting. Specifically, when the metal sheet being cut is placed on the cutting table 12, the sheet closes off the top surface of the sheet support slats 38. This creates space between the individual sheet support slats 38. The sheet above and the baffle pans 36 below thereby form an internal airflow chamber or duct. When dampers 40 are opened in a zone 28, the outside intake airflow is directed to that zone, through the intake air duct 18 of the exhaust system 10 to the intake duct 14 of the cutting table 12 and to the internal chambers 32, 34 of the cutting table 12 to the ends of the sheet support slats 38. This air passes between the sheet support slats 38 across the cutting table 12 beneath the bottom surface of the sheet being cut. This concentrates airflow to the area directly beneath where the cutting is done.

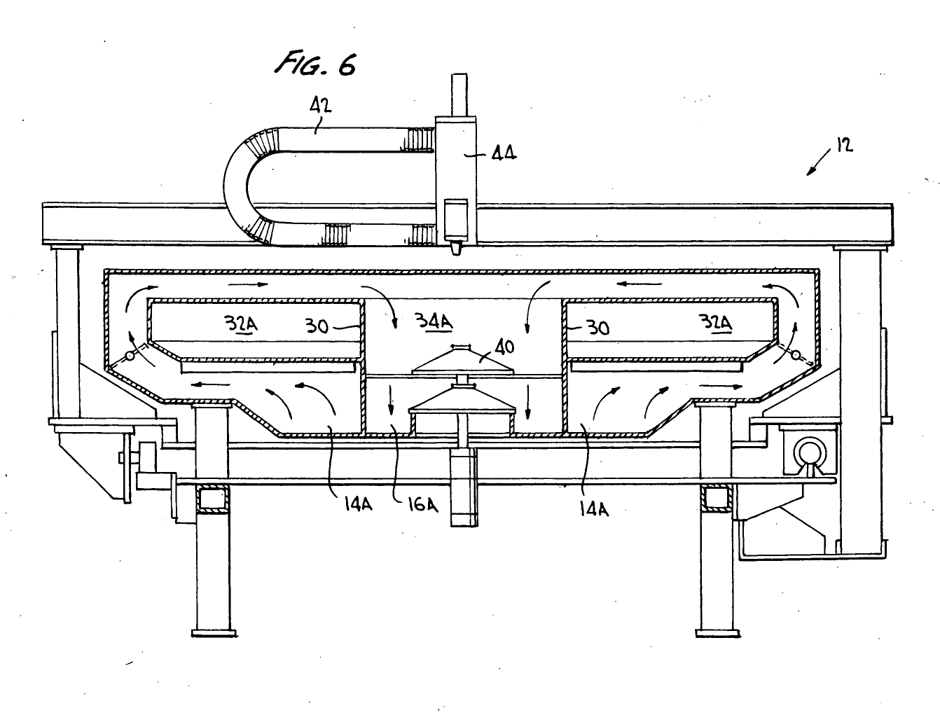

Volume dampers 40 are provided in the intake and/or exhaust chambers 32, 34 in each zone 28. These dampers 40 open and close to control the volume of exhaust airflow through that zone 28 between the internal duct chambers 32, 34 to the cutting area above and the openings in the intake duct 14 and exhaust duct 16 below. These dampers 40 can be placed at a number of possible places and arrangements in each chamber between the intake or exhaust duct openings and the area where cutting is performed. For example, as shown in FIGS. 3 and 4, the cutting table 12 may have a damper 40 in the bottom of the cutting table 12 between exhaust chamber 34 and exhaust duct 16 while no damper is provided between intake chamber 32 and intake duct 14. Also, as shown in FIG. 5, the cutting table 12 can have a damper 40 in each of the intake chamber 32 and exhaust chamber 34. Further, the cutting table 12 may have dual rotating side dampers or may have a zone cutting table and damper design.

The opening and closing of the volume dampers 40 in the cutting table 12 are actuated by the position of a cutting bridge 42 adjacent to the cutting table 12. The movement of the cutting bridge 42 activates the damper actuator and opens or closes the dampers 40 which direct the exhaust airflow to the zones with open dampers. This mechanical action of this particular damper system balances the exhaust drawn between two zones when a cutting torch 44 on the cutting bridge 42 passes across an intersection of two zones. For example, the dampers in zone one close gradually as the torch 44 moves into zone two. At the same time, the dampers in zone two start to open. When the torch 44 moves into zone two, the dampers in zone two open entirely as the dampers in zone one close. The damper opening and closing process repeats itself as the cutting torch 44 moves from zone two to zone three, etc. The damper system design allows air to bleed through the dampers just enough to make sure no residual smoke will escape as cut parts of the metal sheet are removed.

Damper activation can be done in many ways including mechanically as described above, or with either electrical motors or pneumatic air valves and switches as known to those skilled in the art.

In the zone cutting table design with dual air volume control damper as shown for example in FIG. 5, dampers 40 in the intake chambers 32 and the exhaust chambers 34 isolate the exhaust airflow to the one zone where cutting is performed. This makes it possible to remove cut parts of the metal sheet from the cutting table 12 while cutting occurs. The cut parts of the metal sheet can be removed faster to reduce the loading and the unloading time of the cutting table 12. Further, parts of the metal sheet can be removed from other zones of the cutting table 12 where the dampers 40 are closed with no effect on exhaust flow. These airflow volume dampers 40 in both chambers 32, 34 of a zone are opened or closed when the cutting torch bridge 44 passes above the zone. This directs the intake and exhaust airflow from the intake and exhaust ducts 14, 16 beneath the cutting table 12 to the zone 28 with the open damper. This system maintains and increases energy savings, efficiency and performance of the plasma cutting machine even if parts of the metal sheet are removed during cutting thereof.

In another embodiment, as shown in FIG. 6, the exhaust system 10 of the invention has a cutting table 12 having two intake ducts 14A and an exhaust duct 16A therebetween along the bottom of the cutting table 12. The cutting table 12 also has two intake chambers 32A, one along each side of the table, and an exhaust chamber 34A therebetween. Each intake duct 14A brings the outside air supply into the table along a corresponding side of the table, around the corresponding intake chamber 32A and exits though the central exhaust chamber 34A into the exhaust duct 16A. A damper 40 is positioned in exhaust chamber 34A while no damper is provided in intake chambers 32A. Damper 40 operates as set forth above. Further, baffles 30 divide the table into the separate air intake and exhaust chambers 32A, 34A. The intake air and the exhaust air for this embodiment of the cutting table is as defined above and shown in FIG. 2.

The exhaust system of the invention can optionally exhaust air through a filter system (not shown) positioned in the exhaust air duct 20. This design may be provided in accordance with local, state and/or federal regulations.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. An exhaust system for a plasma cutting machine comprising:
a cutting table having at least one chamber with at least one damper therein, wherein said damper controls airflow to or through the at least one chamber;
an intake duct having an outside air intake which supplies the cutting table with an external source of air; and
an exhaust duct which removes smoke generated during cutting of a sheet of metal from the cutting table.

2. The exhaust system for a plasma cutting machine of claim 1, further comprising an intake air duct connecting the intake duct to an opening of the outside air intake.

3. The exhaust system for a plasma cutting machine of claim 1, further comprising an exhaust air duct connecting the exhaust duct to an outside air exhaust opening.

4. The exhaust system for a plasma cutting machine of claim 1, wherein the cutting table comprises a plurality of cutting zones, each of the plurality of cutting zones having at least one chamber with at least one damper therein.

5. The exhaust system for a plasma cutting machine of claim 1, further comprising a plurality of sheet support slats operatively positioned in the at least one chamber of the cutting table to support the sheet of metal.

6. The exhaust system for a plasma cutting machine of claim 1, wherein the at least one chamber includes an intake chamber adjacent to the intake duct and an exhaust chamber adjacent to the exhaust duct.

7. The exhaust system for a plasma cutting machine of claim 4, wherein each of the plurality of cutting zones includes an intake chamber adjacent to the intake duct and an exhaust chamber adjacent to the exhaust duct.

8. The exhaust system for a plasma cutting machine of claim 4, further comprising a plurality of baffles which divide the cutting table into the plurality of cutting zones.

9. The exhaust system for a plasma cutting machine of claim 1, further comprising at least one baffle which divides the cutting table into the at least one chamber.

10. The exhaust system for a plasma cutting machine of claim 6, wherein each of the intake chamber and the exhaust chamber includes a damper which controls airflow to or through the intake chamber and the exhaust chamber.

11. The exhaust system for a plasma cutting machine of claim 4, wherein each damper in the plurality of cutting zones is actuated based on a position of a cutting bridge and a cutting torch of the cutting machine during cutting of the sheet of metal.

12. The exhaust system for a plasma cutting machine of claim 10, wherein each damper in each intake chamber and each exhaust chamber is actuated based on a position of a cutting bridge and a cutting torch of the cutting machine during cutting of the sheet of metal.
